(19) United States
(12) Patent Application Publication
(10) Pub. No.: US 2010/0019646 A1
(43) Pub. Date: Jan. 28, 2010

(54) THERMIONIC EMITTING METAL INTERCALATED GRAPHITIC NANOFIBERS

(76) Inventors: Charles M. Lukehart, Nashville, TN (US); Jason A. Michel, Nashville, TN (US); Timothy Fisher, West Lafayette, IN (US); Vance Robinson, Niskayuna, NY (US)

Correspondence Address: JOHN BRUCKNER, P.C., P.O. BOX 490, FLAGSTAFF, AZ, 86002, US

(21) Appl. No.: 12/309,667

(22) PCT Filed: Jul. 31, 2006
(86) PCT No.: PCT/US06/29539

§ 371 Date: Sep. 25, 2009

(51) Int. Cl. H01J 1/142; H01B 1/24

(52) U.S. Cl. 313/310; 252/503; 977/939; 977/742

(57) ABSTRACT

A carbon-based composition comprising graphite carbon nano-fibers intercalated with a metal useful as a thermionic electron emission material.

### FIELD OF THE INVENTION

The invention relates to the lowering of the work function of graphitic nanofibers by the metal intercalation thereof to enhance their thermionic emission properties.

### BACKGROUND OF THE INVENTION

Devices that employ thermionic emission are used in many contemporary applications that require a stable electron source. These applications Include fluorescent lighting, cathode ray tubes, x-ray tubes, mass spectrometers, vacuum gauges, scanning electron microscopes, and other scientific instruments. Further, thermionic emission is also a viable means of converting heat directly into electrical power. Thermionic converters have been designed to operate in conjunction with various heat sources such as solar radiation, nuclear reactions, and the combustion of fossil fuels. Thermionic power generation has many attractive qualities, including compactness, scalability, and high waste heat rejection temperatures for cascaded systeins [G. Hatsopoulos and E. Oyftopoulos, Thermionic Energy Conversion (MIT Press, Cambridge, Mass., 1973), Vol. 1. And G. Hatsopoulos and E. Oyftopoulos, Thermionic Energy Conversion (MIT Press, Cambridge, Mass., 1979), Vol. 2].

However, the requirement of operation at high temperatures caused by the high work functions of typical thermionic emitter materials has limited the applicability of thermionic power generation. Carbon nanotubes [Y. M. Wong, W. P. Kang, J. L. Davidson, A. Wisitsora-at, K. L. Soh, T. S. Fisher, Q. Li, and J. F. Xu, J. Yac. Sci. Technol. B 21,391 (2003)] and nanofibers [V. Merkulov, D. Lowndes, and L. Baylor, J. Appi. Phys. 89, 1933 (2001)] exhibit outstanding electron field emission properties because of electric field enhancement caused by their large geometric aspect ratios.

As measured by photoelectron emission spectroscopy [M. Shiraishi and M. Ata, Carbon 39, 1913-1917 (2001)], unmodified single—(SWCNTs) and multi walled carbon nanotubes exhibit work functions of σ≈5 eV that are slightly higher than graphite, and the work function of carbon nanofibers is expected to be similar. Suzuki et al [Appl. Phys. Lett. 76, 4007 (2000) first studied the effects of cesium intercalation on the work function of SWCNTs and measured by ultraviolet photoemission spectroscopy a work function of 2.4 eV for the intercalated sample as compared to 4.8 eV for pristine SWCNTs. Other alkali-metal intercalants have also been studied. Suzuki et al. [Phys. Rev. B 67, 115418 (2003)] showed a reduction in work function from 4.6 eV to 3.2 eV in SWCNTs with the addition of potassium, and Choi et al [Phys. Lett. A 299,601 (2002)] measured a reduction in work function of up to 0.2 eV with sodium-intercalated multiwalled carbon nanotubes. In addition, potassium doping of SWCNTs has recently been reported to exhibit a strong effect on field effect transistor device characteristics [A. Javey, R. Tu, D. B. Farmer, J. Guo, R. G. Gordon, and H. Dai, Nano Lett. 5, 345 (2005). See also U.S. Pat. No. 6,885,022

The observed reductions in work function indicate that carbon nanotubes and nanofibers may be useful thermionic emission sources. However, prior measurements have been conducted using photoemission at room temperature and have therefore not interrogated the stability of these materials under actual operating conditions.

Graphitic carbon nanofibers (GCNF) are known to differ materially from carbon nanotubes [Polymer Composites, Vol. 26, no. 2, Pages 128-135 (2005); Composite Interfaces, Volume 11, Number 7, 2004, pp. 525-535(11)].

It is an object of the present invention to ascertain and lower the work function of GCNF materials, thereby enhancing the thermionic emission properties thereof substantially above those that can be obtained with other types of carbon nano structures.

### SUMMARY OF THE INVENTION

The above and other objects are realized by the present invention, one embodiment of which relates to a carbon-based composition comprising graphite carbon nano-fibers intercalated with a metal.

Another embodiment of the invention concerns thermionic electron emission materials comprising the above-described composition.

A further embodiment of the invention comprises a thermionic electron emitting article of manufacture comprising the above-described composition.

Still another embodiment of the invention relates to devices or systems that include a Thermionic emitting material wherein the material comprises the composition described above.

An additional embodiment of the invention concerns articles of manufacture comprising packaging material and a thermionic emitting material contained within the packaging material, wherein the thermionic emitting material emits electrons upon exposure to thermal energy and wherein the packaging material comprises a label which indicates that the thermionic emitting material can be used for the thermionic emission of electrons, and wherein the thermionic emitting material comprises the above-described composition.

### BRIEF DESCRIPTION OF THE DRAWINGS

FIG. 1 is a TEM image of a herringbone GCNF.

FIG. 2 is a powder XRD scan of a composition of the invention.

FIG. 3 shows thermionic electron energy distributions of a composition of the invention compared with a non-intercalated GCNF.

FIG. 4 is representation of GCNF.

### DETAILED DESCRIPTION OF THE INVENTION

The present invention is predicated on the discovery that certain metal intercalated GCNF materials possess unexpectedly low work functions and concomitant enhanced thermionic emission properties. Preferred intercalating metals are the alkali metals. Particularly preferred is potassium.

More particularly, it has unexpectedly found that the thermionic electron energy distributions (TEEDs) from GCNFs with and without potassium intercalation reveal a dramatic reduction in work function from 4.7 eV to 2.2 eV due to the intercalation. This reduction is generally consistent with prior photoemission experiments on fibrous carbon materials with intercalated alkali metals; however an important difference is that the present results were performed at elevated temperatures. These results indicate that the effect can be maintained at the high temperatures required in applications of these materials as thermionic electron sources and energy conversion materials.

The invention is illustrated by the following non-limiting examples in which the herringbone graphitic carbon nanofibers (GCNFs) used were prepared according to published procedures [P. Anderson and N. Rodriguez, J. Mater. Res. 14, 2912 (1999)].

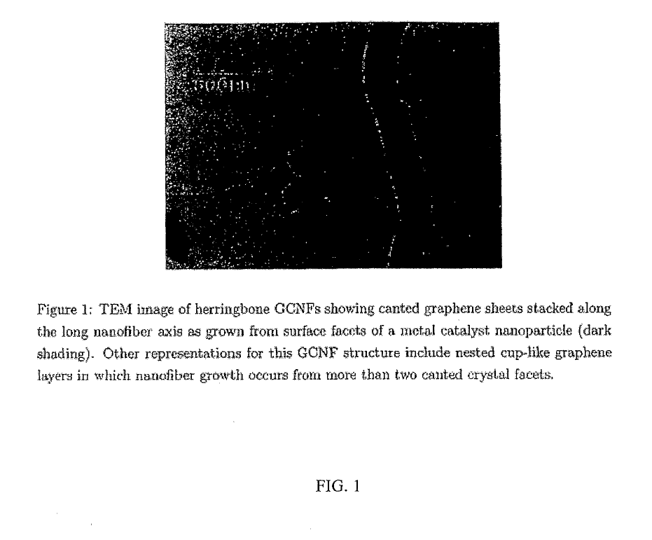

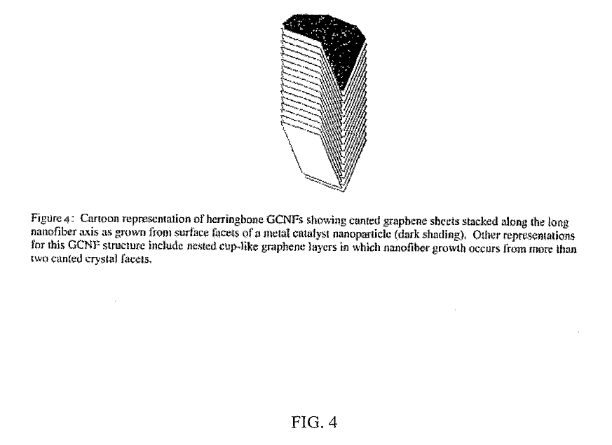

Using a Fe—Cu (7:3) growth catalyst under a flow of C₂H₄/H₂/He(2:1:4) at 600° C. for 1.5, GCNFs (see FIG. 4) are formed from the catalytic decomposition of a carbonaceous gas at the surface of metal growth catalyst nanoparticles. Carbon extracted from the gaseous reagent traverses the growth catalyst particle and deposits on specific facets, forming a carbon nanofiber in a layer-by-layer growth process [N. Rodriguez, J. Mater. Res. 8, 3233 (1993)]. Rodriguez et al [Langmuir 11, 3862 (1995) have shown that the structural form of the resulting nanofiber can be manipulated by varying the metal composition of the growth catalyst and/or the source of carbon. In the following examples, GCNFs having the herringbone graphene plane stacking structure, shown in FIG. 1, have been used. This structure consists of nested graphene (or cuplike) layers canted at ˜90° and stacked in the direction of the long nanofiber axis. Individual GCNFs have diameters determined by the size of the individual growth catalyst nanoparticles and lengths determined by the growth conditions. The graphene-plane stacking pattern of GCNFs is uniquely different from that of single walled carbon nanotubes (SWCNT) or multi-walled nanotubes. As-prepared nanofibers were demineralized by etching away the retained metal growth catalyst with 1 M HCI solution for seven days at room temperature. Demetallated GCNFs were then washed with water and dried to a black powder. Transmission electron microscopy (TEM) micrographs confirm the herringbone structure of the GCNF product with nanofibers typically having diameters of 75-200 nm and lengths on the micron scale [E. S. Steigerwalt, G. A. Deluga. and C. M. Lukehart, J. Phys. Chem. B 106, 760 (2002).

A Stage-1 GCNF-K intercalate was prepared by direct reaction of herringbone GCNFs with the stoichiometric amount of molten potassium under a nitrogen atmosphere (MBraun glove box). A reaction temperature of 250° C. was maintained over 12 h. During reaction, the black GCNFs developed a bronze appearance, indicating formation of the desired intercalate [Henning, J. Phys. Chem. 43 1201 (1965). Intercalated nanofibers were placed in an air-tight die within the glove box and pressed outside the glove box into pellets (13 mm×2 mm), which were returned to the glove box, rinsed, and stored in decane. Upon removal from the decane, the GCNFs' appearance was again black and visually indistinguishable from the nonintercalated sample.

Thermionic energy distributions were measured with a hemispherical energy analyzer (SPEeS-Phoibos 100 SCD) connected to a vacuum chamber that reaches pressures on the order of 10⁻⁸ Torr. When transferred into the vacuum chamber, the sample pellet was briefly exposed to atmospheric air, during which time no observable reaction occurred. The heated emitter sample was located at the focal plane, 40 mm below the analyzer's aperture. The analyzer nozzle, inside the vacuum chamber, was wrapped with copper cooling tubes to prevent heat damage. The temperature of the molybdenum heater (HeatWave Labs, Inc.) was measured by a K-type thermocouple (embedded 1 mm below the top of the molybdenum heater surface) that was connected to a proportional temperature controller. The uncertainty in the temperature measurements for the range of temperatures in this study (600-836° C.) is +20° C.

The heater assembly was thermally and electrically insulated from the chamber by alumina hardware. All energy distributions reported here were measured after the temperature of the emitter had stabilized for at least 20 min. The heater was negatively biased (−4 V) to accelerate electrons into the analyzer and to ensure that the electrons possessed sufficient energy to overcome the work function of the analyzer. Electron acceleration was achieved by connecting the heater assembly to a dc power supply (Hewlett Packard 6542A) and grounding the analyzer's aperture. Voltage sense lines for the dc power supply were implemented, reducing the uncertainty in the acceleration voltage to ±0.3 mV.

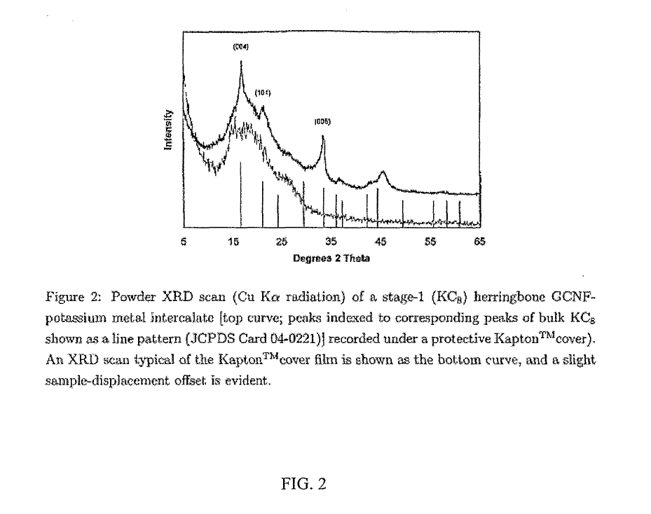

As found with a wide variety of graphitic carbon materials [M. S. Dresselhaus, G. Dresselhaus, J. E. Fischer, and M. J. Moran, Intercalated Graphite, Material Research Symposium Series Vol. 20 (NorthHolland, N.Y., 1983)], direct reaction of herringbone GCNFs with a stoichiometric amount of molten potassium metal gives a Stage-1 KC₈ potassium GCNF intercalate. The resulting powder reacts rapidly upon exposure to ambient atmosphere and should be treated as a pyrophoric material. A powder x-ray diffraction (XRD) scan of an unpressed portion of the GCNF-K intercalate, protected from the atmosphere by a thin Kapton film, is shown in FIG. 2. Formation of the KC₈ stage is evident from the observed diffraction pattern. The expected (004), (101), and (008) diffraction peaks are clearly evident, and diffraction from the (002) planes at ˜270 in 2θ normally observed for as-prepared GCNFs is absent. The (004) diffraction peak of bulk KC₈ is the peak of highest relative intensity and corresponds to the characteristic intercalate repeat distance of ca. 5.35 Å.

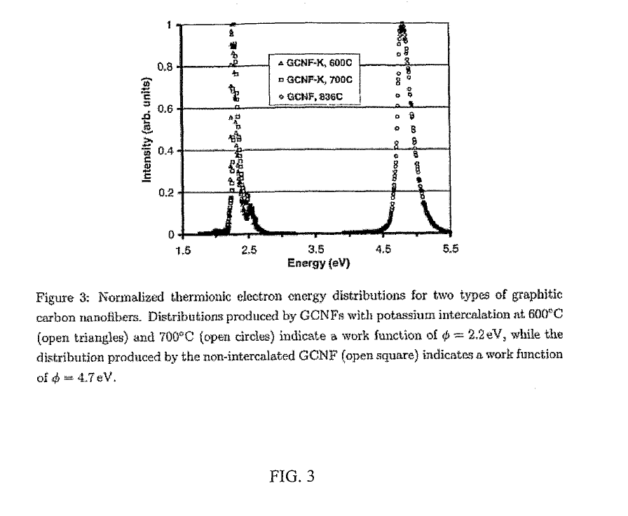

FIG. 3 illustrates the effects of intercalating GCNFs with potassium on work function and thermionic electron energy distributions. Without intercalation, the peak intensity at T=836° C. occurs at 4.8 eV which, after accounting for the thermal energy kT, corresponds to an effective work function of approximately 4.7 eV.

For the K-intercalate sample tested at T=600 and 700° C., peak intensities occur near 2.3 eV, corresponding to an effective work function of approximately 2.2 eV. Thus, intercalating GCNFs with potassium reduces the work function by approximately 2.5 eV. Further, the nature of the energy analyzer measurements suggests that this decrease is an aggregate effect over the entire sample surface and not limited to a local emission site, as indicated by the absence of a graphitic peak in the thermionic electron energy distributions (TEEDs) of the intercalated sample. For the intercalated samples, the effective work function is significantly smaller that that of graphite but similar to that of potassium, suggesting that the potassium dominates in the determination of effective work function. The difference between the work function reported here (σ=2.2 eV) for GCNF-K and that reported by Suzuki et al (σ=3.2 eV) for potassium-intercalated SWCNTs with a K/C ratio of approximately 0.14 (similar to that in the present work) is probably due to the result of differences in intercalate position within the carbon lattice.

In addition to the change in work function, FIG. 3 also shows a decrease in width of the energy distribution with intercalation, as quantified by the distributions' full width at half maximum (FWHM) intensity. The FWHMs are approximately 0.08 eV and 0.24 eV for the intercalated and non intercalated samples, respectively. Part of the energy spread is attributable to instrument effects. The uncertainty associated with the energy analyzer is characterized by the standard deviation a of a Gaussian instrument function which, when combined with the actual energy distribution, produces the observed energy distribution [R. Reifenberger, H. A. Goldberg, and M. J. G. Lee, Surf. Sci. 83, 599 (1978)]. This function depends on instrument slit width and pass energy settings. For all reported cases, these settings were held constant and produced a value of approximately 0.008 eV.

Given that instrument effects were consistent for all experiments, the broader distribution for the nonintercalated sample is attributed, in part, to the slightly higher temperature, which was necessary to permit sufficient electron counts in the experiment. The maximum temperature difference among the experiments (236° C.), accounts for only 0.02 eV of the total 0.16 eV difference according to free-electron theory. Further, it is noted that free-electron theory predicts a FWHM of 2.45 kT [R. D. Young, Phys. Rev. 113,] 10 (1959)], which is remarkably consistent with the results for the non intercalated GCNF (2.45 kT=0.234 eV) but much larger than the observed FWHMs for the GCNF-K sample. The disparity in energy distribution widths thus cannot be explained by free-electron theory. A narrowing of the distribution in the room-temperature photoemission spectra of intercalated SWCNTs was also observed by Suzuki et al who postulated that a hybridized state exists between the nearly free-electron (NFE) state of the SWCNT and an s state of the potassium. Because this NFE state corresponds to an interlayer state in graphite [M. Postemak, A. Baldereschi, A. J. Freeman, E. Wimmer, and M. Weinert, Phys. Rev. Lett. 50, 761 (1983)] this argument would also apply to GCNFs.

It will be understood by those skilled in the art that the intercalated GCNF compositions and articles of the invention may be utilized in any device and/or system requiring thermionic emission of electrons. Such devices include but are not limited to any thermionic cathode, field emission apparatuses containing thermionic electron emitting cathodes, therapeutic radiation sources wherein the electron source includes a thermionic cathode having an electron-emissive surface and adapted to emit electrons when heated to a sufficient temperature by a laser beam, integrated modular thermionic power conversion systems, solid-state thermionic converters for converting heat to electricity comprising an electrically and thermally conductive electron emitter and an electrically and thermally conductive electron collector for receiving electrons from the emitter, and the like.

1. A carbon-based composition comprising graphite carbon nano-fibers intercalated with a metal.

2. A composition of claim 1 wherein said metal is an alkali metal.

3. A composition of claim 2 wherein said alkali metal is potassium.

4. A thermionic electron emission material comprising the composition of claim 1.

5. A thermionic electron emitting article of manufacture comprising a composition of claim 1.

6. A device or system that includes a thermionic emitting material wherein said material comprises the composition of claim 1.

7. An article of manufacture comprising packaging material and a thermionic emitting material contained within said packaging material, wherein said thermionic emitting material emits electrons upon exposure to thermal energy and wherein said packaging material comprises a label which indicates that said thermionic emitting material can be used for the thermionic emission of electrons, and wherein said thermionic emitting material comprises the composition of claim 1.
